(19) United States
(12) Patent Application Publication
(10) Pub. No.: US 2007/0068999 A1
(43) Pub. Date: Mar. 29, 2007

(54) Method for inspecting manually inserted components

(75) Inventors: Jun-Hua Zhu, Taipei (TW); Chiy-Ray Shiue, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/378,937

(22) Filed: Mar. 17, 2006

(30) Foreign Application Priority Data
Sep. 27, 2005 (TW) 094133461

(51) Int. Cl. B23K 31/02; B23K 31/00

(52) U.S. Cl. 228/179.1; 228/214

(57) ABSTRACT

A method for inspecting manually inserted components is proposed, which is used to inspect whether the manually inserted components are correctly assembled on the circuit board. The method for inspecting manually inserted component implements the steps of first inserting the manually inserted components into corresponding positions on the surface of the circuit board, then covering a masking board on the surface of the circuit board, and forming a plurality of openings on the masking board corresponding to where the manually inserted component is assembled on the surface of the circuit board, exposing only the manually inserted components so as to facilitate in inspecting the arrangement of these components inserted on the circuit board and holding these components in place when subsequent soldering process is performed.

### BACKGROUND OF THE INVENTION

1. Field of the Invention

The present invention relates generally to a technology for inspecting assembling state of electronic components, more particularly, a method for inspecting manually inserted components, which facilitate users in inspecting a plurality of manually inserted components assembled on a circuit board for problems such as bad assembly.

2. Description of Related Art

With rapid development of science technology, electronic product has been widely applied in people's daily life, thus, circuit boards are in great demand, PCB (Printed Circuit Board) is an object with conductors disposed on an insulating substrate, on which a variety of electronic components such as resistors, capacitors, diodes, transistors, slots, interface components and the like are attached, and various functions can be fulfilled through electrical connections of the conductors.

Nowadays, PCB structure is becoming increasingly complicated, and in order to upgrade the overall function of circuit boards, a large amount of electronic components are often mounted on the surface of the PCB. At present, the components are almost sheet-type components, so as to fulfill miniaturization of the products. However, in order to meet the requirements for various different electrical designs, many electronic components are still required to be inserted manually on the surface of the PCB, and soldering process for the components is performed on the other surface of the circuit board, so as to solder them onto the circuit board.

Conventionally, when soldering an electronic component on the PCB, the component to be soldered is first manually inserted on a corresponding position on one surface of the circuit board, then, after the component is inspected, the circuit board is titled to a certain angle (generally from five to eight degrees), finally, a soldering process such as wave soldering is performed on the other surface of the circuit board. Since the circuit board is inclined at a certain angle, thus, during solder preheating, the component inserted onto the circuit board but is not fixed to the circuit board may be skewed due to factors such as its own weight or dithering of the wave-soldering track or the like. If the component is, for example, an electrolytic capacitor, it may have no end of line due to deflection, thereby affecting the yield of the circuit board, even if a certain refitting task is employed, operation progress and work efficiency are still affected. Additionally, there is a greater chance of damaging the electrolytic capacitance and sometimes even the circuit board.

Furthermore, at present, there is an inspection step before the soldering operation, in which components are conventionally inspected manually by inspectors without any inspection tools. For example, the inspectors determine and check whether components to be soldered on the circuit board are inserted correctly without problems such as incorrect quantity or reversed polarity of components by comparing them with those shown in a circuit blue print or templet, so as to increase yield of the final circuit board. However, this kind of manual inspection is very time-consuming, minute and inconvenient, which may badly affect work efficiency.

Moreover, at present, there is no inspecting method which can deliver a completely correct component inspecting result. Generally, it is only after the components are soldered, then can the inspectors discover malfunctions such as electrical fault or no end of line on the circuit board. This is not only cumbersome but prone to damage of the components and the circuit board.

Accordingly, there exists a strong need in the art for a method to solve the drawbacks of the above-described conventional technology, so as to further increase the yield of the final circuit board.

### SUMMARY OF THE INVENTION

Accordingly, it is an objective of the present invention to solve the drawbacks of the aforementioned conventional technology by providing a method for inspecting manually inserted components, which is used to avoid the components from skew during a soldering operation, so as to increase yield of the final circuit board.

It is another objective of the present invention to provide a method for inspecting manually inserted component which allows inspector to efficiently inspect whether the components are correctly inserted, so as to avoid problems such as inserting the wrong quantity of components, inserting the components in the wrong positions or wrong polarities.

In order to attain the objectives mentioned above and the others, a method for inspecting manually inserted component is provided according to the present invention, which comprises: inserting the manually inserted components into corresponding positions on a surface of the circuit board, covering a masking board on the surface of the circuit board and forming openings on the masking board at positions corresponding to the positions of the manually inserted components inserted onto the surface of the circuit board, so as to expose only the manually inserted components for inspection and subsequent soldering process.

Wherein, the masking board can firmly hold the manually inserted components on the circuit board, so as to avoid the manually inserted components from dithering or skew during the subsequent soldering operation. Furthermore, the number and size of the openings on the masking board correspond to those of the manually inserted component on the surface of the circuit board, allowing inspectors to efficiently inspect whether the components are correctly inserted, so as to avoid problems such as inserting the wrong quantity of components or inserting the components in the wrong positions or wrong polarities. In addition, for the components such as electrolytic capacitors with positive polarity and negative polarity, marks indicating correct polarities of the manually inserted components can be provided around the openings for inserting those manually inserted components, which allows the inspectors to easily determine whether the polarities of the manually inserted components are in the correct orientation.

Therefore, the method for inspecting manually inserted component according to the present invention mainly employs a masking board to cover a circuit board, allowing only the manually inserted components inserted thereon to be exposed, thus inspection of these components can be easily performed. The masking board further helps to hold the components firmly in place during subsequent soldering process, thereby significantly increasing work efficiency and yield of the final circuit boards.

### BRIEF DESCRIPTION OF DRAWINGS

FIG. 1 depicts an operational flowchart of the method for inspecting manually inserted component according to the present invention.

FIG. 2 depicts a schematic diagram of a masking board structure used in the method for inspecting manually inserted component according to the present invention.

FIG. 3 depicts a schematic diagram when the masking board of FIG. 2 is placed on a circuit board according to the method for inspecting manually inserted component of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be devised without departing from the spirit of the present invention.

In order to illustrate the features and effects of a method for inspecting manually inserted components according to the present invention in a more concise manner, the following embodiment is described using a plurality of manually inserted components surface mounted on a MB (Mother Board) as an example, but application of the present invention is not limited to this.

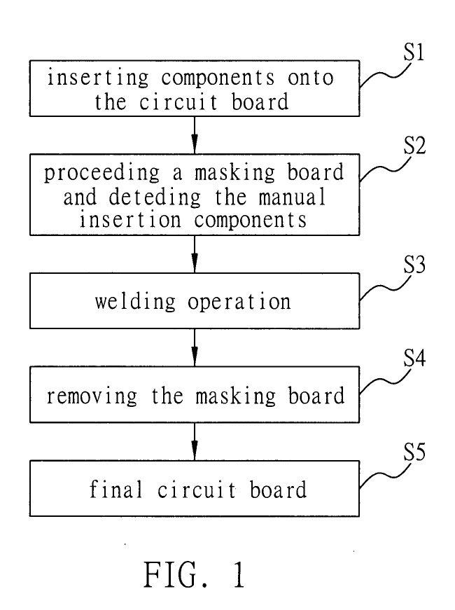

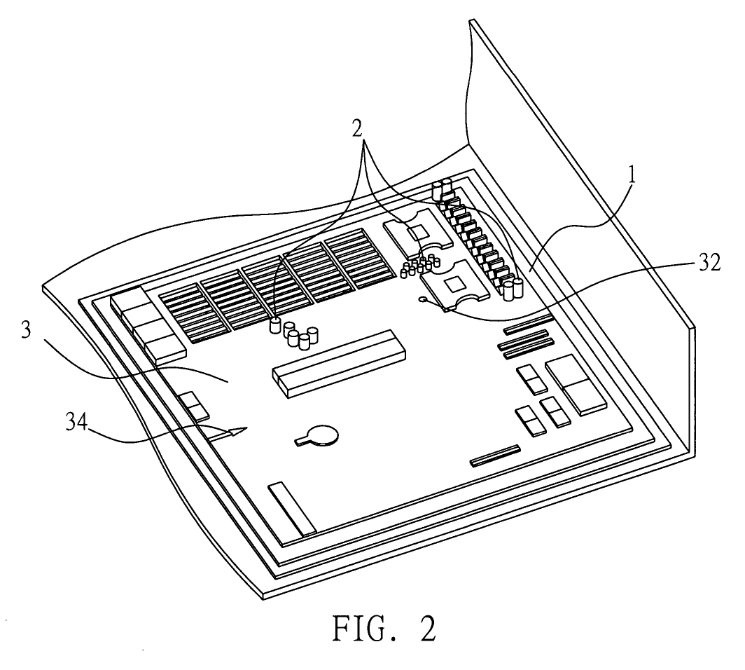

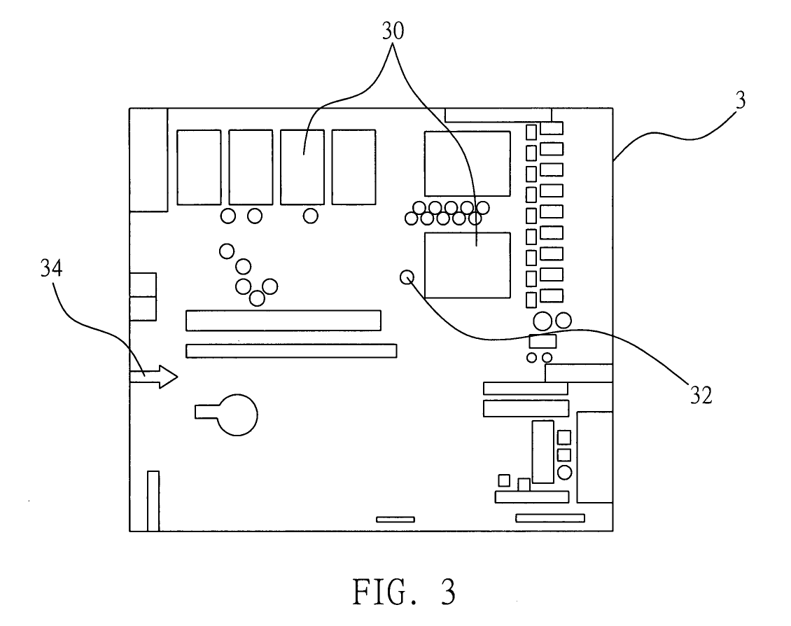

With reference to FIG. 1, shown is an operational flow chart of the method for inspecting manually inserted components according to the present invention, the following will illustrate the implementing steps of the method according to the present invention in conjunction with FIGS. 2 and 3 in detail.

Beginning at step S1 first, inserting a plurality of manually inserted components 2 (as shown in FIG. 2) that are to be soldered into corresponding soldering positions on the surface of a circuit board 1. In the exemplary embodiment, the circuit board 1 is provided with a plurality of openings, e.g., PTH (Plating Through Hole) penetrating through the circuit board 1, for inserting the manually inserted components 2. The manually inserted components 2 can be electronic components, e.g., resistors, capacitors, diodes, transistors, slots, interface components and the like, then proceeding to step S2.

At step S2, providing a masking board 3 (as shown in FIG. 2), and covering the masking board 3 on the surface of the circuit board 1, so as to inspect the validity of insertion of the manually inserted components 2 on the surface of the circuit board 1. With reference to FIG. 2, size of the masking board 3 and the locations of the openings thereon are determined by the size of the circuit board 1 and the arranged locations of the manually inserted components 2 inserted on the surface of the circuit board 1. In the exemplary embodiment, the masking board 3 is a slightly smaller than the circuit board 1 and a plurality of openings 30 are provided on the masking board 3 at locations corresponding to where the manually inserted components 2 are assembled on the surface of the circuit board 1, so as to expose the manually inserted components 2 when the masking board 3 is placed on the circuit board 1. The masking board 3 also can fix the manually inserted components 2 firmly in their correct locations on the circuit board 1, so as to assure that the manually inserted components 2 can be vertically inserted onto the surface of the circuit board 1, thereby preventing the manually inserted components 2 from problems, such as no end of line or electrical fault due to dithering and skew during the subsequent soldering operation, and further affecting the yield of the final circuit board. The number and size of the openings 30 match those of the manually inserted components 2 required to be soldered on the circuit board 1.

In addition, in the present invention, by virtue of the masking board 3, the manually inserted components 2 can be fixed on the surface of the circuit board 1. At the same time, problems such as incorrect number or reversed polarity of the manually inserted components 2 on the surface of the circuit board 1 can be easily determined. For example, for those manually inserted components 2 that have polarity characteristic, such as electrolytic capacitors, diodes and the like, marks 32 indicating polarity of the manually inserted components 2 are provided on the masking board 3 at the surrounding of the openings exposing those components 2, so that the inspectors may easily determine the correct orientation of the components 2 by matching the polarities with the corresponding marks 32. If the inspector finds that the polarity of a manually inserted component 2 does not correspond to the mark(s) 32 shown at the surrounding of the corresponding openings 30, then he/she can quickly determine that this component 2 is inserted wrongly and further correct it. In the exemplary embodiment, the mark 32 can be for example a red dot indicating positive polarity of the manually inserted components 2 disposed at the corresponding side around the corresponding opening 30. The masking board 3 may further provided with an arrow 34 for indicating the board entering direction of the masking board 3 to facilitate correct placement of he masking board 3 (as shown in FIG. 3, shown is a schematic diagram of an embodiment of cooperation of the masking board with the circuit board according to the present invention).

Furthermore, when there is no manually inserted component 2 protruding from an opening of the masking board 3, i.e., the number of the manually inserted components 2 that are required to be inserted onto the surface of the circuit board 1 is inconsistent with the number of the openings disposed at the masking board 3, it indicates that a manually inserted component 2 that should be inserted at the vacant opening is missing. In addition, if the masking board 3 cannot be placed evenly on the circuit board 1 to firmly fix all the manually inserted components 2 thereon, it indicates that one or more of the manually inserted components are inserted in the wrong position. The inspectors may then perform refitting procedure according to the inspection result and the inspecting and correcting steps are repeated until the assembly of the manually inserted components is completely correct, next, proceeding to step S3.

At step S3, after confirming components are correctly inserted in terms of the inserting position, number, type, polarity and the like, performing the soldering operation on the other surface of the circuit board 1, so as to attach the manually inserted components 2 on the circuit board. In the exemplary embodiment, the circuit board 1 is tilted with a certain angle, e.g. from five to eight degree, which facilitates the soldering operation. Since the manually inserted components 2 are covered and fixed firmly on the circuit board 1 by the masking board 3, they will not be affected or skewed by the inclination of the circuit board or dithering in a wave-soldering track. The soldering technology is a conventional technology and not the primary technical content of the present invention, so it will not be described further, then proceeding to step S4.

At step S4, removing the masking board 3 from the circuit board 1 after the soldering process is completed. The manually inserted components 2 are soldered on the circuit board 1 correctly and without skew, thereby effectively preventing the manually inserted components 2 from electrical fault and damage while increasing the yield of the final circuit board.

Therefore, the method for inspecting manually inserted component according to the present invention mainly employs the masking board to cover the circuit board for easy inspection of the inserting state of the components to be soldered on the surface of the circuit board, and also allow those components to be firmly held in place during the soldering process, thereby significantly enhancing inspection accuracy of the manually inserted components and yield of the final circuit board.

The above-described descriptions of the detailed embodiments are only to illustrate the preferred implementation according to the present invention, and it is not to limit the scope of the present invention, i.e., other changes still can be implemented in the present invention. For example, for those circuit boards that have very similar component layout, sometimes a single masking board may be used by simply blocking those unwanted openings. Accordingly, all modifications and variations completed by those with ordinary skill in the art should fall within the scope of present invention defined by the appended claims.

What is claimed is:

1. A method for inspecting manually inserted components on a circuit board, the method comprising:
inserting the manually inserted components into corresponding positions on a surface of the circuit board; and
covering a masking board on the surface of the circuit board and forming openings on the masking board at positions corresponding to positions of the manually inserted components inserted onto the surface of the circuit board, so as to expose only the manually inserted components for inspection and subsequent soldering process.

2. The method for inspecting manually inserted components of claim 1, wherein the manually inserted components include electronic components with positive polarity and negative polarity.

3. The method for inspecting manually inserted components of claim 2, wherein at least one mark indicating a polarity is provided on the masking board at the surrounding of at least one of the openings exposing the electronic components.

4. The method for inspecting manually inserted component of claim 1, wherein the number and size of the openings on the masking board correspond to those of the manually inserted components on the surface of the circuit board.

5. The method for inspecting manually inserted component of claim 1, further comprising performing a soldering process to solder the manually inserted components on the other surface of the circuit board.

6. The method for inspecting manually inserted component of claim 5, wherein after the soldering process, further comprising removing the masking board.
